(19) United States
(12) Patent Application Publication
(10) Pub. No.: US 2003/0216945 A1
(43) Pub. Date: Nov. 20, 2003

(54) Method for analyzing orders and automatically reacting to them with appropriate responses

(76) Inventors: Carl D. Dvorak, Madison, WI (US); Khiang Seow, Madison, WI (US); Brian Stoll, Madison, WI (US); Brent Warner, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/395,998

(22) Filed: Mar. 25, 2003

Related U.S. Application Data
(60) Provisional application No. 60/367,588, filed on Mar. 25, 2002.

(51) Int. Cl. G06F 17/60

(52) U.S. Cl. 705/3

(57) ABSTRACT

A method of responding to an order placed in a patient's electronic medical record including receiving the order associated with the patient, determining a type of the order, identifying a task template associated with the order, and linking the task template to the order. The method also includes determining if an overriding template exists for the order, linking the overriding template to the order if the overriding template exists, and reacting to the order with a response, wherein the response is one of the following responses: scheduling a task on a work list, adding a row to a flowsheet, adding an educational topic to an educational record associated with the patient, adding a care plan intervention to the patient's electronic medical record, sending a notification, executing a custom programming, or adding a group of text to a discharge instruction associated with the patient.

### CROSS-REFERENCE TO RELATED APPLICATIONS

This application claims priority to U.S. Provisional Application Serial No. 60/367,588, entitled “A Method for Analyzing Orders and Automatically Reacting to Them With Appropriate Responses,” filed Mar. 25, 2002 (attorney docket no. 29794/38218), the disclosure of which is hereby expressly incorporated herein by reference.

### TECHNICAL FIELD

The present patent relates generally to the ability of computer software to modify itself based on user input, and more particularly, the patent relates to software responding to orders placed in an electronic medical record (EMR).

### BACKGROUND

In a healthcare setting, many aspects of patient care are tied to orders. Orders can be placed for a wide variety of things, including medical procedures and medications. Orders involve more than a physician simply placing an order—they can involve multiple tasks performed by different people at different times. As a result of an order, more information may need to be collected about a patient's condition—for example, if an order is placed for Digoxin, a caregiver needs to check the patient's apical pulse. Also, orders may lead to the need to address additional interventions or educational topics for the patient.

With so many different caregivers responsible for various aspects of a patient's care, communication between the caregivers is a challenge. An individual order placed by a physician may have several components that are not specifically stated. For example, an order for pain medication may involve components including administering the medication, evaluating and documenting the patient's level of pain, and teaching the patient about the medication, with different caregivers only able to perform certain functions based on their qualifications. This information must be communicated to multiple people so that all of the order components are fulfilled.

In a traditional paper-based healthcare setting, much of the communication between caregivers is verbal once the original orders and tasks have been recorded. This makes communication more difficult since there is not a reference as to what tasks other caregivers may be doing, and caregivers are responsible for keeping track of all of their tasks on their own. In addition, some of the tasks that caregivers perform are not communicated through any sort of written or verbal communication—it is assumed that the caregivers, given their experience, training, and knowledge of the healthcare setting's policies, know that certain tasks must be performed when a particular order or task is to be completed. In the example above, the task of taking a patient's apical pulse may not be communicated to the caregiver—the caregiver may have to rely on his or her own training to know that an order of Digoxin requires checking the patient's pulse. In a busy healthcare environment with multiple patients, there is a chance that a task such as this may be forgotten, or not completed at the appropriate time.

Finally, the act of keeping track of all of the work required by any given order can be complex and time consuming—information regarding a patient's care can be located in various places in the chart, making caregivers spend more time looking for the task information that they need.

Most attempts at solving these problems involve the organization of orders, but do not use a centralized location to track the various other duties that stem from the original order. By using a paper Kardex report, caregivers can keep track of all of the orders that have been placed for a patient and note when they are completed. However, this report is not considered part of the patient's permanent record, and documentation of these tasks must be kept elsewhere as well. Therefore, in order to keep themselves organized, caregivers must document their duties and the completion of them in more than one location.

Paper systems do not easily accommodate the division of tasks—there is not an individual whose main duty is to determine what additional tasks must be done to fulfill an order and who should complete each step. Paper systems do not automatically respond to a particular order's needs. For example, if additional information should be documented on a flowsheet (a chart with patient information tracked over time) due to an order, in a paper system the caregiver would have to find space on the flowsheet to include the new statistics. Since the flowsheet is usually a tri-fold piece of paper that is all-inclusive of the patient's information, finding new information can be challenging. Paper systems also consume more organizational time and run a greater risk of information being lost as it is communicated to multiple people.

In addition to paper systems, scheduling methods using greaseboards also exist. In these systems, a list of patients and the tasks that need to be done for their care are listed on an erasable board. Like paper systems, greaseboard schedules do not automatically respond to the needs of a particular order. In addition, although everyone can view them, it is not well defined who can perform specific tasks listed. Since the greaseboard information can only be found in one place, all caregivers must physically move to that one location to collect information on tasks that must be done. In addition, due to laws protecting the privacy of patients, the greaseboards may not have complete information about the patients and their needs. There is also a greater risk for error in such systems—someone might write down a task for the wrong patient, or information on the board may be accidentally erased.

### BRIEF DESCRIPTION OF THE DRAWINGS

The present patent is illustrated by way of example and not limitation in the accompanying figures, in which like references indicate similar elements, and in which:

FIG. 1 illustrates in block diagram an overview of an embodiment of an activity assignment system.

FIGS. 2A and 2B illustrate exemplary user interfaces for a Task Template record.

FIG. 3 illustrates an embodiment of a user interface for entering information into a Task Record.

FIG. 4 is a flowchart illustrating some of the steps that are used in finding an appropriate Task Template.

FIG. 5 is a flowchart representation of some of the steps used to schedule tasks for a Work List.

FIG. 6 illustrates in flowchart form some of the steps used in adding rows to a flowsheet.

FIG. 7 is a flowchart representation of some of the steps by which an educational title, topic, or teaching point is added to the patient's education record.

FIG. 8 is a flowchart representation of some of the steps by which a care plan intervention is added, once a Task Template has been located.

FIG. 9 is a flowchart representation of some of the steps through which notifications are sent.

FIG. 10 is a flowchart representation of some of the steps through which the activity assignment system can execute additional actions not generally defined via custom programming.

FIG. 11 is a flowchart representation of some of the steps through which the activity assignment system 10 automatically adds text to a patient's discharge instructions.

### DETAILED DESCRIPTION OF THE DRAWINGS

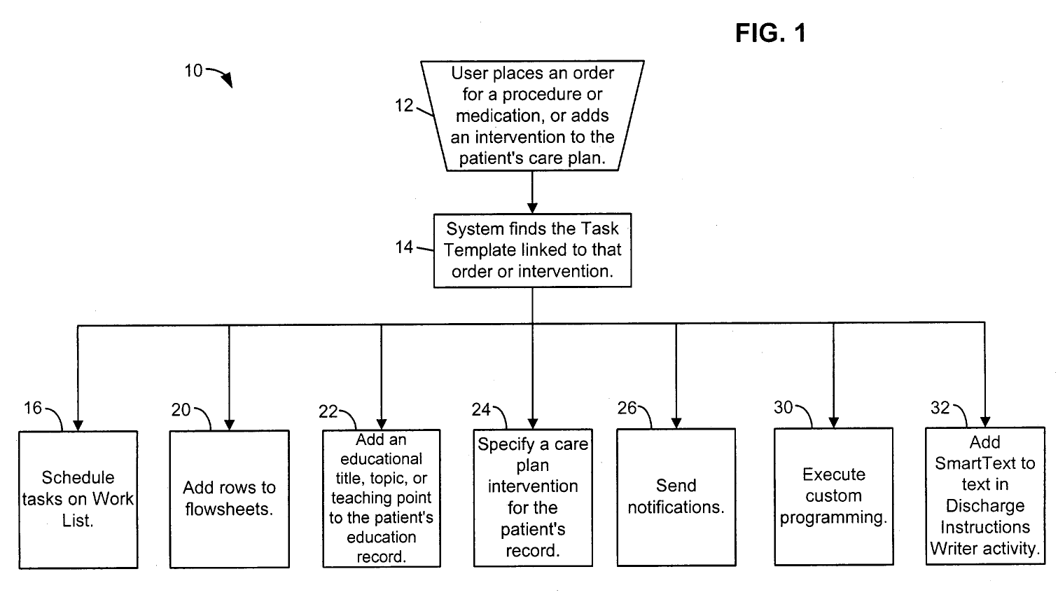

FIG. 1 illustrates an overview of an embodiment of an activity assignment system 10 that analyzes orders and automatically reacts to them with appropriate responses. As a general overview, the activity assignment system 10 may be part of an integrated suite of software used for the administration and management of healthcare. The activity assignment system 10 is a system that may determine the times that tasks (i.e. projects, activities, responsibilities, etc.) are to be performed as well as assigning those tasks. As described in greater detail below, the activity assignment system 10 may analyze orders placed and react to them in a variety of ways. The activity assignment system 10 may break down the orders into multiple tasks, customize a user interface, and take other actions based on the order that has been placed.

The activity assignment system 10 includes the ability to automatically generate order components that may not be specifically stated in an original order, and place those components on a list where caregivers have access to them. The activity assignment system 10 may automatically customize a user interface based on the orders placed, such as adding rows (i.e. rows) to a flowsheet. The system 10 also enhances communication between caregivers by automatically sending out notifications to one or more people when specified.

Illustrated in a block 12 of FIG. 1, a user may place an order for a procedure, a medication, or an intervention to a patient's care plan. Once an order is placed or a care plan intervention is added, the activity assignment system 10 looks for a Task Template linked to that order or intervention at a block 14. In this context, the term “Task Template” shall refer to a template that holds information that is used to automatically react to an order or the addition of a care plan intervention with the appropriate responses. Also in this context, the term “care plan intervention” is intended to refer to a step that is added to a patient's plan of care to work toward eliminating one of the patient's problems. The activity assignment system 10 may include a care integrator activity that allows a user to view, add, and edit problems that have been added to a patient's plan of care.

The Task Templates specify the actions that should be taken for each given order or intervention. These actions include scheduling tasks on a Work List (block 16), wherein the Work List displays information concerning tasks scheduled to care for admitted patients. The list of patients in the Work List is based on the patients appearing on a patient list selected when the Work List is opened. The patient list is a listing of patients from which a Work List is built.

One type of patient list is a system-level patient list that is defined by certain criteria, and includes patients who fit the list's criteria. The list may be updated automatically, adding and removing patients as necessary. Another type of patient list is built by users and includes patients selected by the users of the list.

Another action that could be taken for a given order or intervention includes adding rows to a particular flowsheet (block 20). Another action includes adding an educational title, topic or teaching point, to a patient's education record (block 22). Educational titles, topics and teaching points refer to educational materials that can be added to patients' education records in order to help them learn about their illnesses or the medications that they are taking, for example. Other examples of actions include adding interventions to the patient's care plan (block 24), and launching any notifications programming points (block 26).

Additional actions may also include executing any additional actions using custom programming (block 30), as well as adding designated text (SmartText) to a patient's discharge instructions (block 32). In this context, the term “SmartText” shall refer to a template or block of text created by a caregiver or the healthcare facility that can be used in a variety of locations throughout the software suite (depending on the defined text type). A software product directed to the application of SmartText is commercially available from Epic Systems Corporation of Madison, Wis. Also, a patient's “discharge instructions” are comments and instructions entered by caregivers for patients when they leave the hospital. The instructions can include information such as, for example, what medications the patient is currently taking and what the patient should be eating.

In addition to specifications on how the interface should react to the orders, the Task Template may also contain a record for each component that makes up the order. Multiple Task Records can be associated with a Task Template, covering all of the elements of the order that must be completed. In this context, the term “Task Record” refers to specific information collected to generate a task.

The information found in the Task Templates and the Task Records associated with the templates may be used by the activity assignment system 10 to automatically react to each order or intervention with appropriate responses. Some responses may alter an associated user interface based on the order or care plan intervention (described above), while others add tasks (components of the original order) to the system.

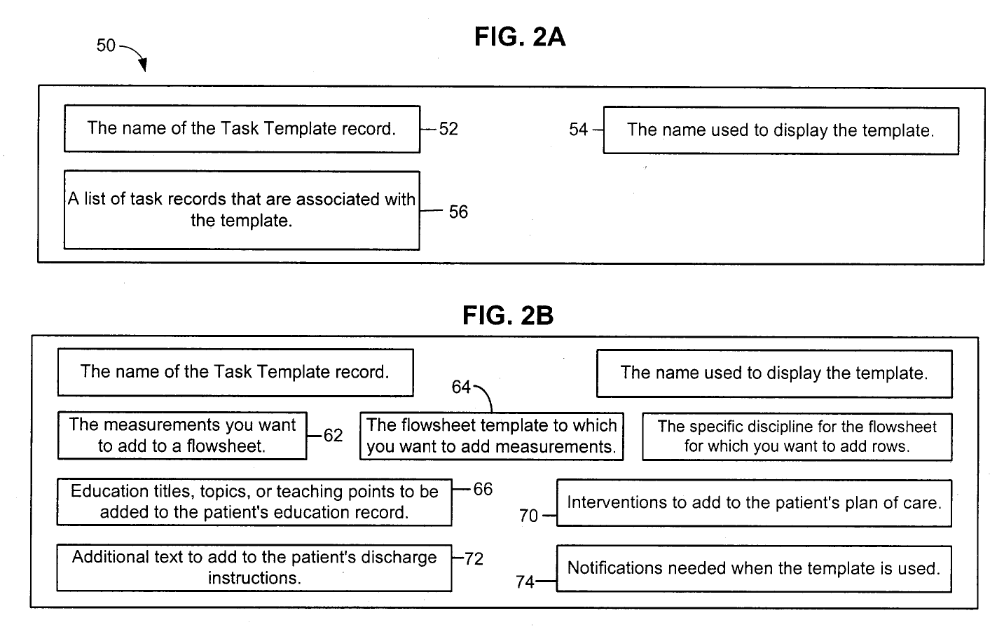

FIGS. 2A and 2B illustrates embodiments of a first and a second user interface for a Task Template record into which a user may enter information using a plurality of data entry fields. It should be noted that only users with the proper security clearance can access the template records.

In FIG. 2A, the user interface 50 of the Task Template record allows the user to enter in both a name for the template (which can be used to look up the template again for modifications) at an entry field 52 and the display name of the template at an entry field 54. It is through this user interface 50, in an entry field 56, that the user can specify the Task Records that should be associated with this task. Each Task Record is entered on an individual line, and the user can press F6, or any other key configured as a shortcut, to move from the template record to the Task Record and view the information the Task Record contains.

In FIG. 2B, the exemplary embodiment of a user interface 60 of the Task Template record allows the user to specify the actions that will be taken once the template is identified for an order or for the addition of a care plan intervention. On this user interface 60, the user can specify the measurements that should be added to a particular flowsheet at an entry field 62 and measurements that should be added to a specific discipline's flowsheet at an entry field 64. The user can also fill in specific titles, topics, or teaching points that should be added to the patient's education record at an entry field 66, and any interventions to be added to the patient's plan of care at an entry field 70. Titles, topics, and points refer to educational materials that can be added to patients' education records in order to help them to learn about their illnesses or the medications that they are taking. In addition, text can be designated on this screen at an entry field 72 to add to the patient's discharge instructions, or a notification can be set up at an entry field 74 to launch when the template is accessed.

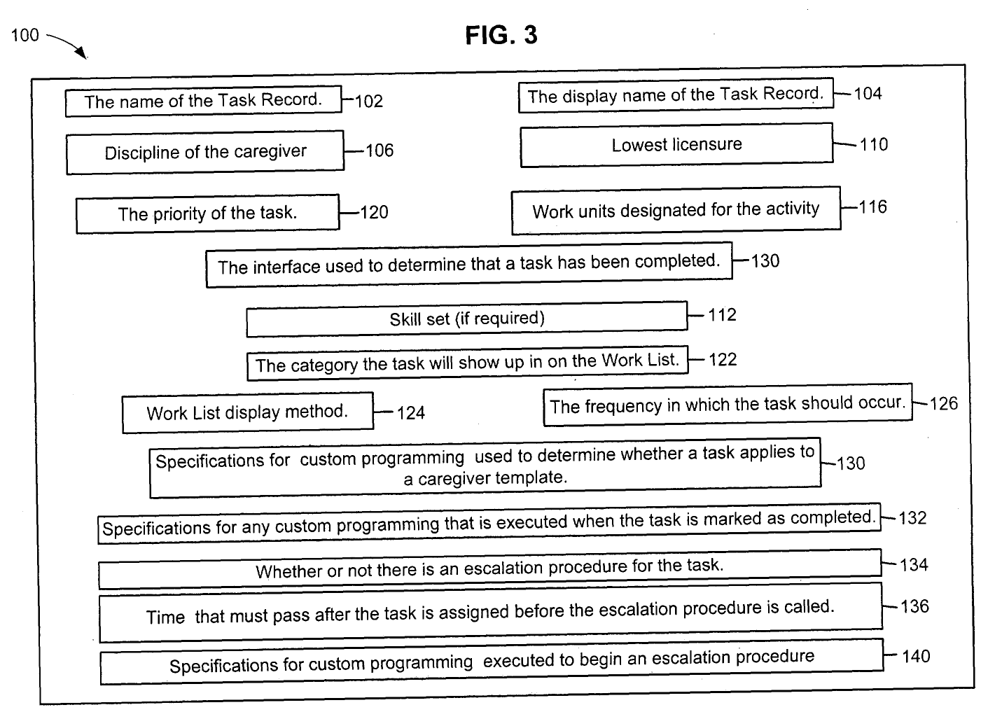

FIG. 3 illustrates an embodiment of a user interface 100 for entering information into a Task Record. As with the Task Template record, only users with the proper security clearance can access the Task Record.

In the Task Record's user interface 100, the user can specify the name and display name of the task at data entry fields 102 and 104 respectively. The user can also specify the information that will be used to determine who can perform the task (and thus is used in task filtering), including the discipline of the caregiver that can perform the task at an entry field 106. In this context, the term “discipline” refers to the area in which the caregiver has been trained, such as nursing, physical therapy, or respiration therapy. The actual person doing the activity would depend on the licensures in that discipline. The term “licensure” in this context shall refer to the level of certification that the user has achieved in the medical field, such as, for example, R.N., M.D., or L.P.N. The user may specifiy the lowest caregiver licensure that can fulfill the duty at an entry field 110. The user may also specify any required skill sets that the caregiver must have at an entry field 112, wherein the term “skill sets” is intended to refer to the expertise of the care giver, such as chemotherapy administrator, central line draw, etc.

As an example, if an RN must perform an IV push, then the discipline might be Nursing and the minimum licensure would be RN. The Task record also has an entry field where custom programming can be specified that can be used to determine whether a task applies to a caregiver, using criteria other than that supplied through the template.

Users entering information into the Task Record at an entry field 116 are able to specify how many work units that the task will take, which can be used to judge staffing needs and employee productivity. The work units designated for the activity may be a numeric value used to represent the work that will be done when the activity is complete.

Other options in the Task Record may determine how the task will be scheduled. The user can enter in information about the priority of the task (low to high) at an entry field 120 and the category in which the task will display at an entry field 122 (for example, a Digoxin order could be set up to display in a Medications category). The Task record also can contain information on how the Work List displays when a task should be performed—either using the frequency at which the task should be performed as a number of times per day, followed by the number of times the task has been performed on that day, or by a set time to complete the task. The method of displaying the Work List can be entered at an entry field 124. Any frequency instructions included with the original order can be overridden at an entry field 126.

The Task Record may also specify information on completing tasks. In an entry field 130, the user can designate what interface is used to document that the task has been completed—whether it is by noting new values in a flowsheet or adding a note to the patient's record. When the user clicks on the task in the Work List, he/she may be brought to the necessary activity tab to complete the assigned task. If the entry field 130 is left blank, clicking on the activity in the Work List will simply check it off as done.

Custom programming can be specified at an entry field 132 to take actions once the completion of the task has occurred. A number of entry fields deal with the escalation of tasks, where the user can specify if escalation should take place if the task is not completed during a certain time frame (defined in the Task Record as well). The entry fields associated with escalation are entry fields 134 and 136. An entry field 140 may also be used to specify what form a task escalation should take (i.e. an escalation procedure for the task if it is overdue).

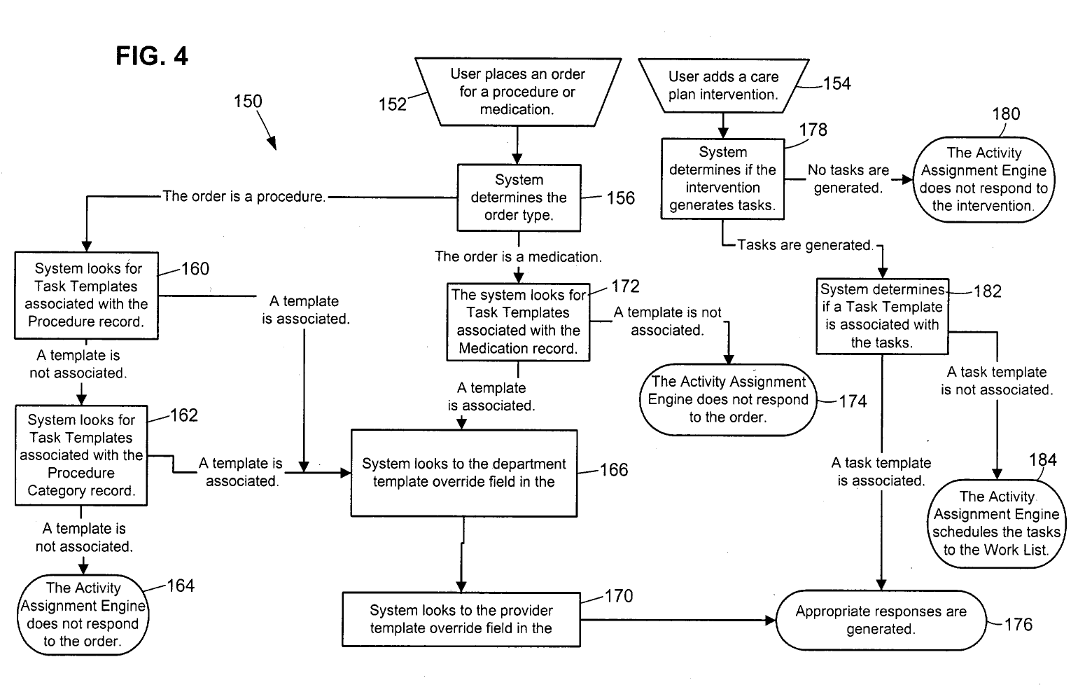

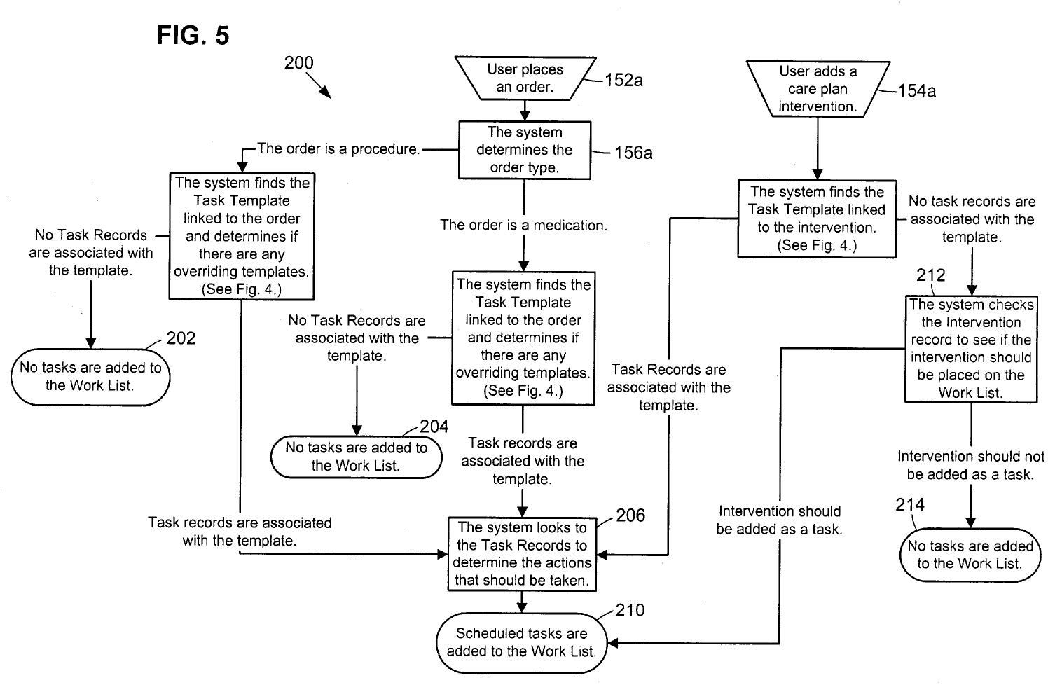

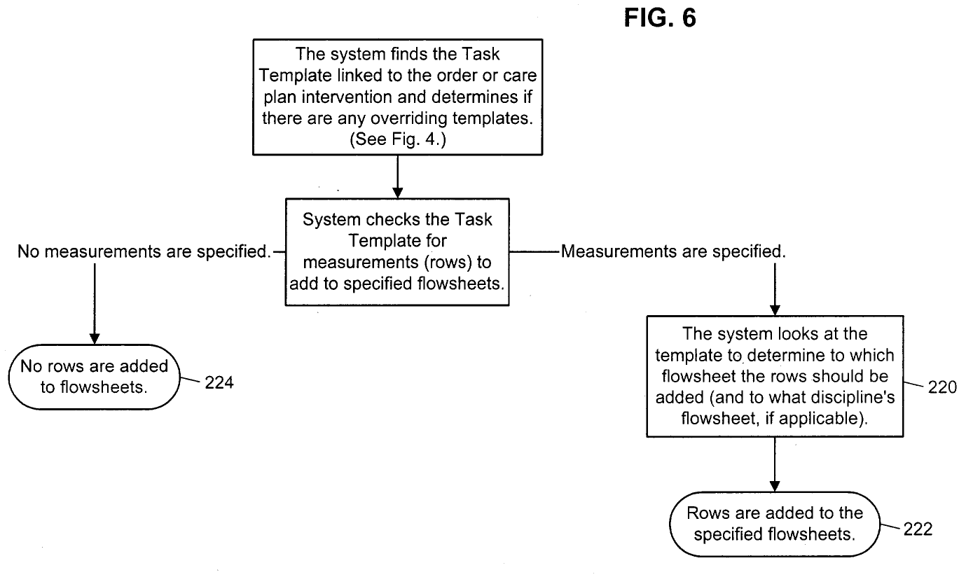

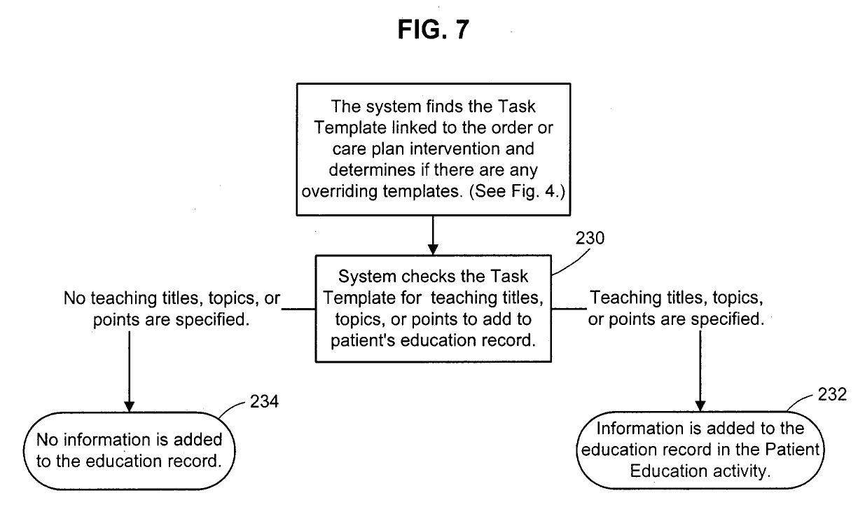

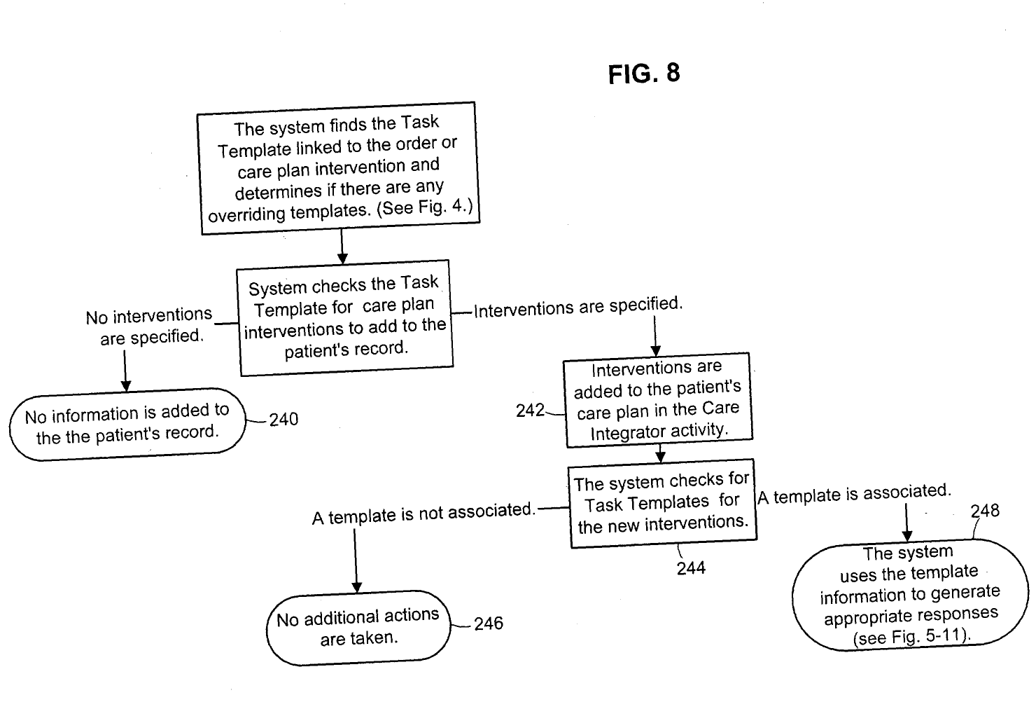

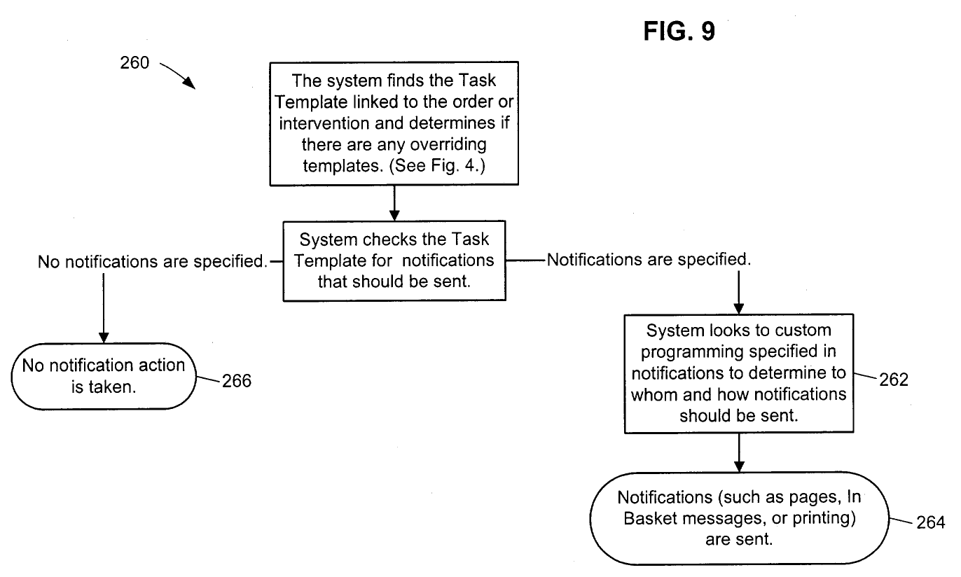

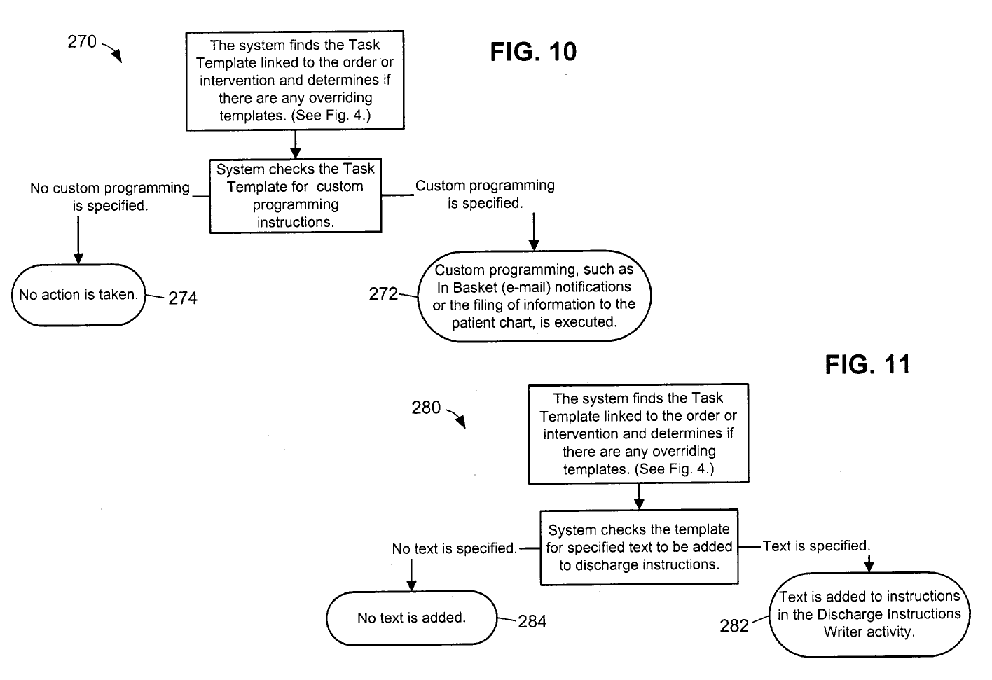

FIG. 4 illustrates a flowchart 150 of some of the steps that occur after an order is placed (block 152) or a care plan intervention is added (block 154) to find the Task Template (recorded in the corresponding Medication, Procedure, Procedure Category, or Intervention Type master file) and handle any overriding template settings.

The first thing that is determined to find the Task Template for an order is the type of order that has been placed (block 156)—whether it is a procedure (including laboratory tests and imaging orders) or medication order. If an order has not been placed, but a care plan intervention has been added, a Task Template may be located through a slightly different process.

If an order has been placed for a procedure, a next step in finding the appropriate Task Template is to look to the Procedure record (block 160). If no templates are associated with this record, the activity assignment system 10 looks to a Procedure Category record (block 162). If there are also no templates associated with that record, the activity assignment system 10 does not respond to the order (block 164). However, if a template is associated with either the Procedure or Procedure Category record for the order placed, a next step in the process—a search for an overriding template—may begin. In the Procedure or Procedure Category record, an overriding template can be specified at the department (block 166) or the provider level (block 170). The Procedure or Procedure Category record can list multiple departments and templates that should be associated with each; if the department in which the order was placed appears in the list, the template listed with that department may override the template that is associated with the Procedure or Procedure category record (block 166). If the provider that placed the order is listed in the Procedure or Procedure category record with yet a different template, that template may override any template at the department level or at the Procedure or Procedure category record level (block 170).

For example, if a doctor in the West Family Practice department places an order for a complete manual hemogram (CBC), to locate a Task Template, the system may first look to the Procedure record for the CBC. If a template is specified in that record, the system may then look to see if that record has any template overrides at the department level. If there is an overriding Task Template for the West Family Practice department specified, the Task Template at the Procedure level may not be used. Then, if in the Procedure record there is an overriding template for the particular provider that placed the order, the template associated with the provider may be used instead of that of the procedure or department. If there is not a Task Template associated with that provider, the one specified at the department level (for West Family Practice) may be used. If an overriding template is not specified at the department or provider level, the template at the Procedure level may be used.

If a template is not specified at the level of the procedure (CBC), the system may look for a Task Template that is associated with the Procedure Category for that procedure, Laboratory/Pathology. If a template is associated with the Procedure Category, the same checks in that record for department and provider overrides may be made. If a template is not associated with the Procedure Category, the activity assignment system 10 may not respond to the order.

Medication orders are dealt with similarly. If an order has been placed for a medication, the system may first look in the Medication record for the Task Template (block 172). If a template is not associated here, the activity assignment system 10 may not respond to the order (block 174). If a template is associated, the system may look to the department and ordering provider settings found in the Medication record,. as detailed above (blocks 166 and 170). Then the appropriate responses to the order may be generated 176.

If a care plan intervention has been added (block 154), the activity assignment system 10 determines whether the intervention generates tasks (block 178). If no tasks are generated with the intervention, the activity assignment system 10 may not respond to the intervention (block 180). If tasks are generated with the intervention, the system 10 may determine if a Task Template is associated with the Intervention record (block 182). If a template is not associated, the activity assignment system 10 schedules a task to the Work List with the frequency of the intervention (block 184). If a template is associated, no further override checks are made, and the appropriate responses are generated (block 176).

FIGS. 5-11 illustrate an exemplary process once the Task Template has been located and any overriding information has been considered.

With the appropriate information entered in the Task Template, the activity assignment system 10 can react to the order with one or more of several possible responses (see FIG. 1). Examples of possible responses are: (1) scheduling tasks onto the Work List (block 16); (2) adding rows to flowsheets (block 20); (3) adding an educational topic for the patient's education record (block 22); (4) adding a care plan intervention for the patient's record (block 24); (5) sending notifications (block 26); (6) executing custom programming (block 30); and (7) adding text to discharge instructions (block 32). The activity assignment system 10 may be configured so that it does not respond to orders that do not have Task Templates associated with them.

FIG. 5 is a flowchart 200 illustrating some of the steps used to schedule tasks for a Work List through the activity assignment system 10. After an order is identified as a procedure or medication order (block 152a), or a care plan intervention has been added (block 154a), the system 10 may find the Task Template linked to the order (see FIG. 4).

Prior to the user placing an order or adding a care plan intervention; information regarding the tasks may be set up ahead of time. This is done through the creation of Task Records (see FIG. 3) and Task Templates (see FIG. 2). The Task Template specifies the Task Records that should be used to create scheduled tasks. The template to be used is then specified in the record for the order or care plan intervention.

For example, assume that when a physician places an order for Digoxin, two tasks should be scheduled on the Work List. Every six hours, a nurse should administer a dose of Digoxin. Since there is a small margin of error in administering Digoxin, a nurse should monitor the patient's heart rate each hour. To accomplish this, two Task Records are created, one for administering the Digoxin and one for checking the patient's pulse rate. These Task Records are recorded on a Task Template, along with any other actions the activity assignment system 10 should take in response to the order. Finally, the Task Template is recorded in the medication record for Digoxin.

For procedure and medication orders, if no Task Records are associated with the Task Template, no tasks are added to the list (blocks 202 and 204). If Task Records are associated with the template, the activity assignment system 10 may refer to these records (block 206) and use the information in them to create scheduled tasks for the Work List (block 210).

Care plan interventions operate similarly. If Task Records are associated with the Task Template, the activity assignment system 10 may use the Task Record information (block 206) to create scheduled tasks on the Work List (block 210). If Task Records are not associated with the template, the system may check the intervention record to see if the intervention has been designated as a task to be placed on the Work List (block 212). If the intervention has been constructed as such, it may be added to the Work List as a task (block 210). If the intervention has not been identified as a task, no tasks are added to the list (block 214).

FIG. 6 illustrates in flowchart form some of the steps used in the activity assignment system 10 to add rows to a flowsheet, wherein each row represents a specific task. Flowsheets may be incorporated into the Documentation Flowsheet, Intake/Output, and MAR activities in the software suite, and are used in the healthcare setting to track patient information over time in a spreadsheet-like format (consisting of groups of rows in a template). In this context, the term “Documentation Flowsheet” shall refer to a flowsheet used to document patients' vitals information, as well as other patient information used by the facility. The term “Intake/Output” refers to a healthcare facility's ability to record and graph a patient's daily intake and output at regular time intervals. Caregivers can record and track different types of fluid intake or output that a patient has received, such as emesis, blood, or urine. It should also be noted that the term “MAR” shall refer to the ability of a caregiver to view and document many aspects of a patient's receipt of a medication, including, for example: when a patient is scheduled to receive a medication; how the medication was administered; where the medication was administered; and whether any interactions exist.

A default flowsheet for each of the activities may be set up at the department level, and only in the Documentation Flowsheet can the caregiver change the flowsheet into which he or she is entering information by selecting from a list of available flowsheets.

Before rows can be added to a flowsheet, the activity assignment system 10 locates the Task Template linked to the order or care plan intervention and determines if there are any overriding templates (see FIG. 4). If flowsheet row measurements are specified in the Task Template, the activity assignment system 10 may look to this information (block 220)—the rows that are to be added, the flowsheet to which the rows should be added, and the specific discipline's flowsheet to which the rows should be added (if applicable)—to determine what actions to take (see FIG. 2). Rows may then be added to the flowsheet(s) that were specified in the Task Template (block 222). If row and flowsheet information is not specified in the Task Template, the activity assignment system 10 may not take this action (block 224).

For example, if the Task Template associated with a medication order for Digoxin specifies that a flowsheet row for the recording of a patient's pulse be added to a patient care flowsheet that can be used in the Documentation Flowsheet activity, the activity assignment system 10 may add the row to that flowsheet. The user can then view the new row by accessing that activity in the software suite, and, if that flowsheet is not immediately available as the default, the user can select the desired flowsheet and enter in the patient's information.

FIG. 7 is a flowchart representation of some of the steps by which an educational title, topic, or teaching point is added to the patient's education record. The patient's education record may be available through a Patient Education activity, and include information that the caregivers use to make sure the patient is learning the things that he or she needs to know in order to cope with a condition or to understand treatments and procedures. For example, a Task Template associated with a Digoxin order could specify that a treatment teaching point be added to the patient's education record that stipulates the patient should be educated so that he or she continues to take his or her own pulse before taking the medication upon returning home.

Once the Task Template has been located (see FIG. 4), if teaching points or topics have been specified in the template (block 230), they may be added to the record (block 232). The activity assignment system 10 may not populate the education record when utilizing templates that do not contain this information (block 234).

FIG. 8 is a flowchart representation of some of the steps by which a care plan intervention is added, once a Task Template has been located (see FIG. 4). If interventions have not been specified, the activity assignment system 10 may not produce any interventions (block 240). If any interventions have been specified in the Task Template, the activity assignment system 10 may add them to the patient's care plan (block 242).

Any interventions that are added may also have Task Templates associated with them. The activity assignment system 10 looks for a Task Template that is associated with the new care plan intervention (block 244). If a template is not associated with the intervention, the activity assignment system 10 may not add any information to the patient's record (block 246). If a template is associated, the activity assignment system 10 may perform the actions specified in the template (block 248) (see FIGS. 5-11).

For example, the Task Template associated the medication order of Digoxin could stipulate that an intervention of acknowledging the patient's fear and anxiety of having heart trouble should be added to the patient's plan of care. That intervention in turn could stipulate in its Task Template that an educational topic calling for the patient to receive a book or pamphlet on his or her condition be added to the patient's education record.

FIG. 9 is a flowchart representation 260 of some of the steps through which notifications are sent. After the Task Template has been located (see FIG. 4), the activity assignment system 10 may send notifications for the order if the notifications are specified in the template. These notifications may comprise custom programming that stipulates what sort of notification should be sent as well as to whom or what should be sent (block 262). Notifications can take various forms, including, for example, sending information via an In Basket (e-mail) message, a page, or a printout (block 264). If no notifications are specified, the activity assignment system 10 may not take any action (block 266). As an example, the Task Template associated with the Digoxin order could stipulate that a report of the patient's Digoxin blood levels be printed.

FIG. 10 is a flowchart representation 270 of some of the steps through which the activity assignment system 10 can execute additional actions not generally defined via custom programming. After the Task Template has been located (see FIG. 4), the activity assignment system 10 may execute custom programming if it is specified in the Template (block 272). If no custom programming is specified, the activity assignment system 10 may not take any action (block 274).

Examples of custom programming that could be put into place include sending In Basket (e-mail) messages to ancillary caregivers; or having discrete data filed to a patient's chart to be reported on later or to set a flag. For example, an In Basket message could be sent to a physical therapist that will be taking care of the patient, or if there was an order to set the patient as do not resuscitate (DNR), a flag for that order could be set through custom programming.

FIG. 11 is a flowchart representation 280 of some of the steps through which the activity assignment system 10 automatically adds text to a patient's discharge instructions. A patient's discharge instructions give the patient instructions for when they leave the hospital, and may be located in a Discharge Instructions Writer activity in the software suite. The Discharge Instructions may be written in free text, or automatically generated.

Once the Task Template has been located (see FIG. 4), if SmartText is specified, it may be added to the discharge instructions (block 282). If no text is specified, the activity assignment system 10 may not take any action (block 284). For example, the Task Template associated with the Digoxin order could specify that a block of text detailing the types of activities that the patient should avoid be added to the patient's discharge instructions.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A method of responding to an order placed in a patient's electronic medical record comprising:
receiving the order associated with the patient;
determining a type of the order;
identifying a task template associated with the order;
linking the task template to the order;
determining if an overriding template exists for the order;
linking the overriding template to the order if the overriding template exists;
reacting to the order with a response, wherein the response is one of the following responses: scheduling a task on a work list, adding a row to a flowsheet, adding an educational topic to an educational record associated with the patient, adding a care plan intervention to the patient's electronic medical record, sending a notification, executing a custom programming, or adding a group of text to a discharge instruction associated with the patient.
